(19) United States
(12) Patent Application Publication
(10) Pub. No.: US 2018/0272252 A1
(43) Pub. Date: Sep. 27, 2018

(54) DEVICES, SYSTEMS AND METHODS FOR PASSIVELY ENHANCING GAS EVOLUTION AND DISSOLUTION RATES

(71) Applicant: Chevron U.S.A. Inc., San Ramon, CA (US)

(72) Inventors: Aniruddha V. Kelkar, Houston, TX (US); David M. Lavenson, Houston, TX (US)

(21) Appl. No.: 15/469,134

(22) Filed: Mar. 24, 2017

(51) Int. Cl. B01D 19/00; E21B 43/12; E21B 43/38

(52) U.S. Cl. CPC B01D 19/0042; E21B 43/38; E21B 43/122

(57) ABSTRACT

Devices, systems and methods for changing a state of a gas relative to a liquid are disclosed. The device includes a section of conduit for containing a multiphase fluid including a liquid and gas, and at least one capillary within the section of conduit. The capillary has a first capillary end open to the flowing gas for receiving gas and a second capillary end open to a flowing liquid for expelling gas into the flowing liquid thus forming bubbles in the flowing liquid. Through the use of the device, gas can be passively transferred from the flowing gas to the flowing liquid. The device is suitable for use in fluid handling systems located downstream of a substantial change in pressure.

### TECHNICAL FIELD

The present disclosure relates generally to gas evolution and dissolution, and more specifically to affecting the rates of gas evolution from liquid and gas dissolution into liquid.

### BACKGROUND

Gas evolution is a physical or chemical process where gas is disengaged from solution, i.e., produced as free gas or bubbles or foam from a supersaturated solution. A supersaturated solution stores more gas than the “saturation level” governed by thermodynamics (e.g., system pressure, temperature, and composition). Gas dissolution is a different physical or chemical process by which a gas in the form of free gas, bubbles or foam enters into or is transferred to an undersaturated solution. An undersaturated solution stores less gas than the thermodynamic “saturation level.” Factors such as system temperature and pressure, level of agitation, and fluid properties affect gas evolution and gas dissolution. Gas evolution and dissolution are encountered in and can be used in a number of applications. Several oil and gas industry operations involve both gas evolution and dissolution, including, but not limited to, sulfur degassing, gas lift, artificial lift using electric submersible pumps (ESPs) and separations.

It would be desirable to effect gas evolution and dissolution rates in such operations in a more controlled and reliable way.

### SUMMARY

In general, in one aspect, the disclosure relates to a device for changing a state of a gas relative to a liquid. The device includes a section of conduit having at least one inner wall that forms a cavity for containing a multiphase fluid including a liquid and gas flowing therethrough. The device also includes at least one capillary within the cavity having a first capillary end open to the flowing gas for receiving gas and a second capillary end open to a flowing liquid for expelling gas into the flowing liquid. Through the use of the device, gas is passively transferred from the flowing gas to the flowing liquid and the transferred gas forms bubbles in the flowing liquid.

In another aspect, the disclosure relates to a fluid handling system including at least one section of conduit for flowing a multiphase fluid comprising a liquid and a gas therethrough and at least one system component in fluid communication with the at least one section of conduit. The multiphase fluid is subjected to at least one substantial change in pressure. The above-described device is located in the fluid handling system downstream of the substantial change in pressure.

In yet another aspect, the disclosure relates to a method of changing a state of a gas relative to a liquid. The method includes flowing a multiphase fluid including a liquid in the gas through a section of conduit having at least one inner wall forming a cavity such that a gas-liquid interface is present in the cavity. A capillary is located within the cavity having a first capillary end open to the flowing gas for receiving gas and a second capillary end open to the flowing liquid for expelling gas into the flowing liquid. A stream of the gas is passively received into the first capillary end open to the flowing gas and the stream of the gas is expelled from the second capillary end into the flowing liquid thereby forming bubbles of the gas in the flowing liquid.

These and other aspects, objects, features, and embodiments will be apparent from the following description and the appended claims.

### BRIEF DESCRIPTION OF THE DRAWINGS

The drawings illustrate only example embodiments of methods, systems, and devices for affecting rates of gas evolution and dissolution. Example embodiments can be applied to any of a number of applications. For instance, example embodiments can be used during a production field operation of a subterranean formation. Therefore, example embodiments described herein are not to be considered limiting of its scope, as affecting rates of gas evolution and/or dissolution may admit to other equally effective embodiments and/or applications. This is similarly applied to drawings illustrating any systems described herein. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show a device for evolving and dissolving gas in accordance with certain example embodiments.

FIG. 2 shows a sulfur degassing unit using the device for evolving and dissolving gas in accordance with certain example embodiments.

FIG. 3 shows a gas lift well using the device for evolving and dissolving gas in accordance with certain example embodiments.

FIG. 4 shows a pumping system using the device for evolving and dissolving gas in accordance with certain example embodiments.

FIGS. 5A and 5B show separation systems using the device for evolving and dissolving gas in accordance with certain example embodiments.

### DETAILED DESCRIPTION OF EXAMPLE EMBODIMENTS

The example embodiments discussed herein are directed to systems, apparatus, and methods of affecting or enhancing the rates of gas evolution from liquid and gas dissolution into liquid. Example systems for affecting rates for evolving and dissolving gases described herein can be used in any type of container in which a gas can be evolved and/or dissolved. Example embodiments can be used in any of a number of applications, including but not limited to production field operations, industrial operations, production of plastics, volcanic activity, sulfur removal pits, diving, solutions produced through electrolysis, chemical plants, biomedical practice, separators, pumps, tanks, and production facilities.

For example, gas-liquid separation is a critical unit operation in crude oil production. In typical upstream oil and gas operations, the multiphase fluids produced from oil wells are separated and processed before being exported as sales and waste streams. These multiphase fluids present numerous challenges in processing, where any issues in design and operation of separators create bottlenecks requiring equipment adjustments. These alterations add operating costs, increase downtime, and/or reduced throughput, all of which result in lost value.

As another example, the unexpected evolution of additional gas in a pipeline or flowline can lead to concerns such as unplanned slugging, increased backpressure, and over prediction of pressure drop, particularly with more viscous liquids. This can compromise the integrity of the flowlines, risers, topsides, and other equipment. For proper design of compact systems, engineers must be able to determine the residence time required to meet the desired outlet gas volume fraction (GVF) specifications with reasonable certainty. Enhancing the rate of evolution and dissolution of gas using example embodiments can mitigate these problems.

In one embodiment, the disclosure relates to a device for changing a state of a gas relative to a liquid. A liquid as used herein can be any one or more substances that are free flowing and having constant volume. Examples of a liquid can include, but are not limited to, water, drilling mud, blood, liquid sulfur, polymers, and oil. A gas as used herein can be one or more of any air-like fluid substances that expand freely to fill any space available (e.g., head space). A gas as used herein can be a free gas, bubbles, gas that is in solution, and/or foam. Examples of a gas can include, but are not limited to, natural gas, nitrogen, methane, air, hydrogen sulfide, carbon monoxide, and carbon dioxide.

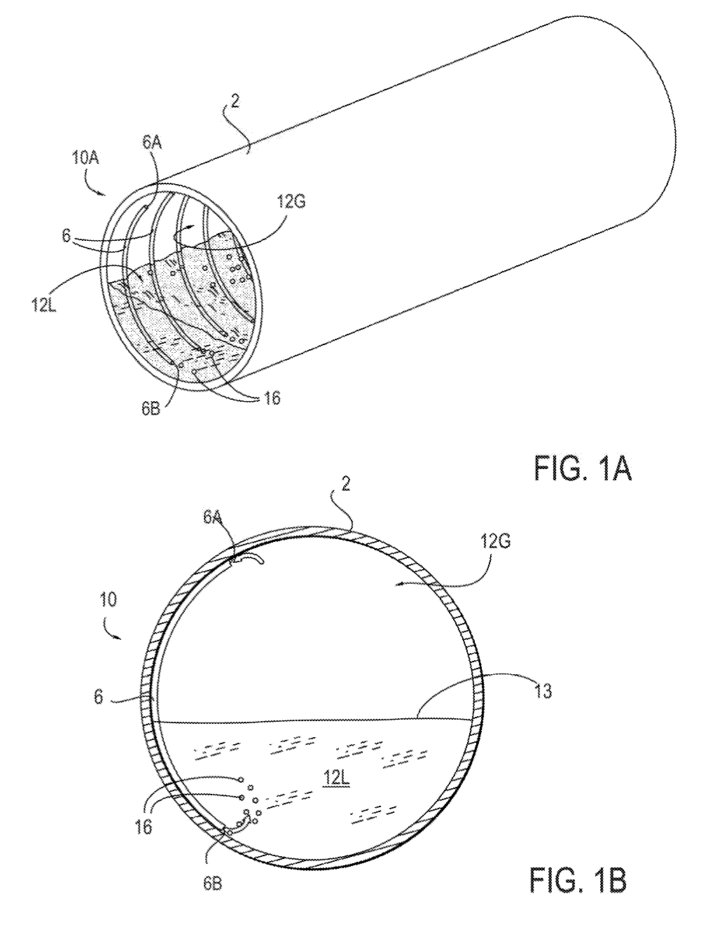

Referring to FIGS. 1A and 1B, the device 10 includes a section of conduit 2 of any size having an inner wall that forms a cavity. In one embodiment, the section of conduit 2 has an inner diameter from 0.6 cm to 152 cm. The cavity can contain a multiphase fluid 12 including a liquid 12L having gas 12G flowing therethrough. A gas-liquid interface 13 is present in the cavity at the intersection of the gas phase 12G and the liquid phase 12L. In one embodiment, the section of conduit 2 can be a horizontal pipe with two-phase (gas/liquid) stratified flow there through, with a slow moving liquid phase 12L at the bottom of the pipe and a faster moving gas phase 12G at the top.

The device 10 includes at least one capillary 6 within the cavity in the section of conduit 2 having a first capillary end 6A open to the flowing gas 12G for receiving gas and a second capillary end 6B open to a volume of flowing liquid 12L. As shown, in one embodiment, the capillary 6 can be a circumferential capillary attached so that the first capillary end 6A is near the top of the pipe above the gas-liquid interface 13 and the second capillary end 6B is below the gas-liquid interface 13. The first capillary end 6A can be oriented to face the flow of gas 12G. This arrangement essentially short circuits the flow of gas, sending some of it into the bulk liquid 12L.

In one embodiment, the capillary 6 has an inner diameter from 1 mm to 100 mm. In one nonlimiting example, the capillary 6 is physically supported by the inner wall of the conduit 2.

Through the use of the device 10, gas is transferred from the upper portion of the cavity in the conduit 2 to the flowing liquid 12L through the capillary 6. In use, a stream of the gas 12G is passively received into the first capillary end 6A and is expelled from the second capillary end 6B into the flowing liquid 12L The gas 12G can enter the capillary 6 and its kinetic energy overcomes capillary pressures in the capillary 6, pushes the liquid inside the capillary 6 out and creates bubbles 16 of the gas 12G within the liquid 12L. The introduced bubbles 16 enhance the rates of gas dissolution or evolution as dictated by the thermodynamic state of the specific system. The bubbles 16 can have an average diameter of less than 1 μm. In another embodiment, the bubbles 16 can have an average diameter of greater than 1 μm.

The liquid 12L and the gas 12G can be in solution as a result of thermodynamic conditions with each other and/or out of solution relative to each other. Separating the gas 12G from the liquid 12L is evolution of the gas, and integrating the gas 12G with the liquid 12L is dissolution of the gas. When the gas 12G is integrated with the liquid 12L, the gas is suspended in the liquid. There may or may not be bubbles of gas 12G in the liquid 12L. The gas 12G can be a foam within or on top of the liquid 12L. In other words, the gas 12G mixed in the liquid 12L can have any one or more of a number of forms.

Through the evolution process within the cavity in the conduit 2, the gas 12G evolves (separates from the liquid 12L) and accumulates in the headspace above interface 13. When the gas 12G dissolves, at least most of the gas 12G (to the extent that the liquid 12L becomes saturated and can no longer absorb additional quantities of the gas 12G) leaves the headspace and becomes suspended in the liquid 12L.

In one embodiment, shown in FIG. 1A, the second capillary end 6B is located within the bottom half of the volume of the flowing liquid 12L in the cavity in the conduit 2. This can be advantageous when the flowing liquid 12L is a low viscosity liquid, since the bubbles 16 move more quickly through lower viscosity liquids. By locating the second capillary end 6B within the bottom half of the volume of liquid, a higher residence time for the bubbles 16 can be provided. This can be advantageous when it is desired to dissolve the gas 12G into the liquid 12L.

In another embodiment, shown in FIG. 1B, the second capillary end 6B is located within the top quarter of the volume of flowing liquid 12L in the cavity in the conduit 2. This can be advantageous when the flowing liquid 12L is a high viscosity liquid, when it is undesirable to wait for the bubbles 16 to move through the liquid 12L.

In one embodiment, the inner surface 6 of the capillary 6 is hydrophobic. The capillary 6 can be formed of a hydrophobic material. In one embodiment, the inner surface of the capillary 6 is oleophobic. The capillary 6 can be formed of an oleophobic material. In one embodiment, the inner surface of the capillary 6 is coated with a coating that can be a hydrophobic or oleophobic coating. The coating of the inner surface of the capillary 6 can be one or more of any of a number of materials (e.g., carbon nanotubes, nano-silica, polytetrafluoroethylene (PTFE), Gore-Tex®, fluorocarbons, perfluorocarbons (PFCs)) having one or more of any of a number of characteristics (e.g., smooth, adhesive, repellant). (Gore-Tex is a registered trademark of W. L. Gore and Associates.)

The coating can be hydrophobic, super-hydrophobic, oleophobic, have some other characteristic, or have any combination thereof. For example, the coating can be both hydrophobic and oleophobic to allow for increasing gas evolution regardless of the continuous phase liquid throughout the production life. The coating can be applied to the inner surface of the capillary 6 evenly, unevenly, randomly, in a pattern, and/or in any other fashion.

In one embodiment, the disclosure relates to a fluid handling system using the device 10 for changing a state of a gas relative to a liquid. The fluid handling system includes at least one section of conduit for flowing the multiphase fluid 12 therethrough. At least one system component is in fluid communication with the at least one section of conduit 2. The system component can be any suitable fluid handling components such as, but not limited to, pipes, pipe fittings, pipe bends, valves, pumps, venturis, reducers and combinations thereof. The multiphase fluid 12 is subjected to at least one substantial change in pressure. By “substantial change in pressure” is meant an increase or decrease in pressure of 10% or 10 psi, whichever is lower. In one embodiment, the at least one substantial change in pressure coincides with the at least one system component. The device 10 as described above can be employed at a location in the system downstream of the substantial change in pressure.

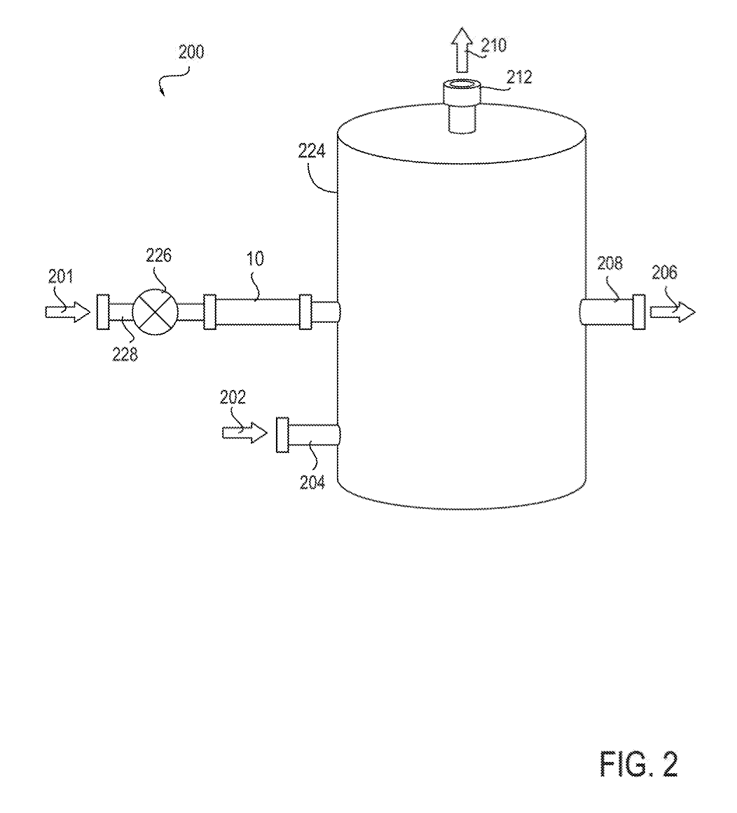

For example, as shown in FIG. 2, in one embodiment, the fluid handling system can be a sulfur degassing unit 200 and the at least one system component can be a degassing vessel 224 for removing hydrogen sulfide and/or hydrogen polysulfide gas from liquid sulfur. The device 10 is located downstream of a valve 226 on an inlet line 228 feeding a multiphase fluid 201 containing liquid sulphur and hydrogen sulfide and/or hydrogen polysulfide gas to the degassing vessel 224. Process gas 202 is fed through process gas inlet 204. Liquid sulfur 206 having been degassed is removed from the vessel 224 through outlet 208. hydrogen sulfide and/or hydrogen polysulfide gas 210 is removed from the vessel 224 through outlet 212. The first and second capillary ends 6A and 6B are located in the device 10 within the inlet 228. Hydrogen sulfide and/or hydrogen polysulfide gas is received by the first capillary end 6A of the capillary 6 and expelled from the second capillary end 6B thereby facilitating removal of the hydrogen sulfide and/or hydrogen polysulfide gas from the liquid sulfur in the inlet line 228. In this embodiment, the substantial change in pressure, i.e., a pressure decrease, coincides with the valve 226 on inlet line 228.

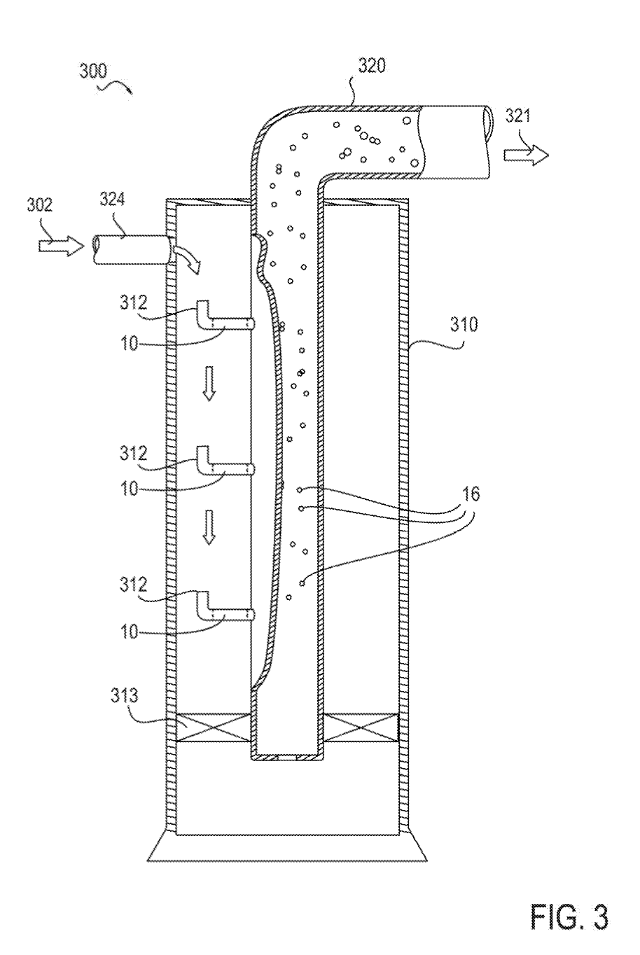

As shown in FIG. 3, in another embodiment, the fluid handling system can be a gas lift well 300 for supplementing formation gas to lift production fluids from a subterranean reservoir 310. The gas lift well 300 has at least one unloading valve 312 for injecting gas 302 through an injection gas inlet 324 in communication with the unloading valve 312 into a production tubular 320 for conveying production fluids 321 from the subterranean reservoir 310. The device 10 can be located such that the first capillary end 6A is located within the unloading valve 312 and the second capillary end 6B is located at or near the opening of the unloading valve 312 to the production tubular 320 (either within the production tubular 320 or just upstream of the production tubular 320). Gas can thus be received by the first capillary end 6A and expelled from the second capillary end 6B, thereby facilitating gas lift to lift production fluids from the reservoir 310. In this embodiment, the substantial change in pressure coincides with a pressure decrease at the valve 312.

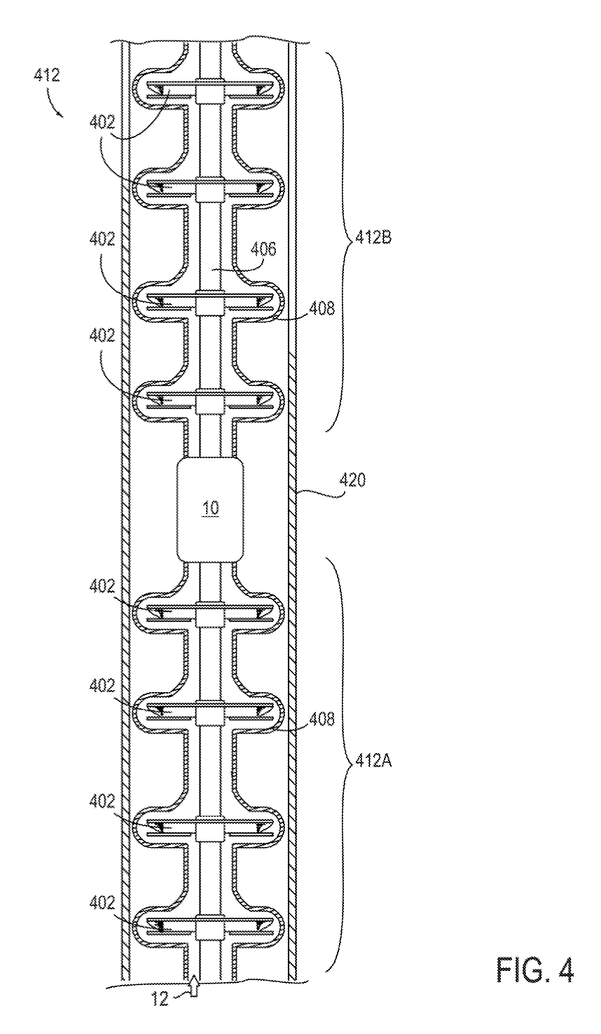

In one embodiment, the fluid handling system can be a pump to facilitate the transfer of a liquid and/or gas from one location to another. In this embodiment, the substantial change in pressure coincides with increased pressure resulting from pumping the fluid. The pump can use any of a number of suitable technologies. For example, the pump can be a continuous flow syringe pump. As another example, the pump can be a piston cylinder pump. In a nonlimiting example, multiphase (gas/liquid) fluids 12 may enter an electric submersible pump (ESP). It is very important for proper ESP operation that the pressurized fluids downstream of a stage have reached equilibrium. If gas dissolution is kinetically impeded, however, the fluids may not equilibrate and the free gas fraction entering the next stage of the ESP may exceed design limits. This adversely affects ESP performance and thus the production rates. In one embodiment (not shown), the device 10 can be located within a pump inlet leading to the pump body. In one embodiment, shown in FIG. 4, the pump is a multistage pump 412 having separate pump stages, e.g., 412A and 412B, so that the fluid 12 is pressurized in stages. Within each stage, the fluid is passed by rotating impellers 402 driven by shaft 406 over stationary diffusers 408. The device 10 can be located between the pump stages within the pump housing 420.

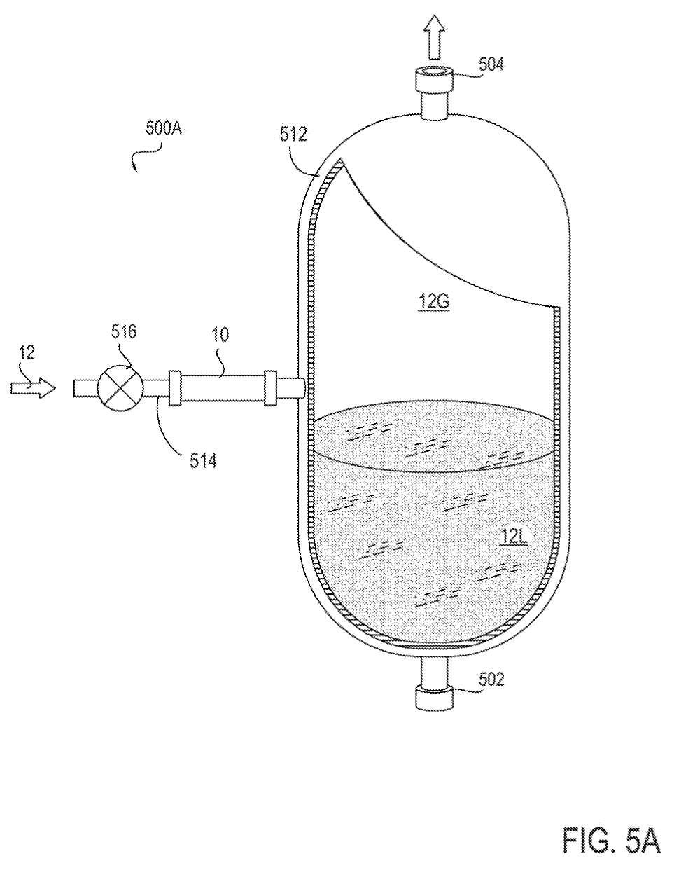

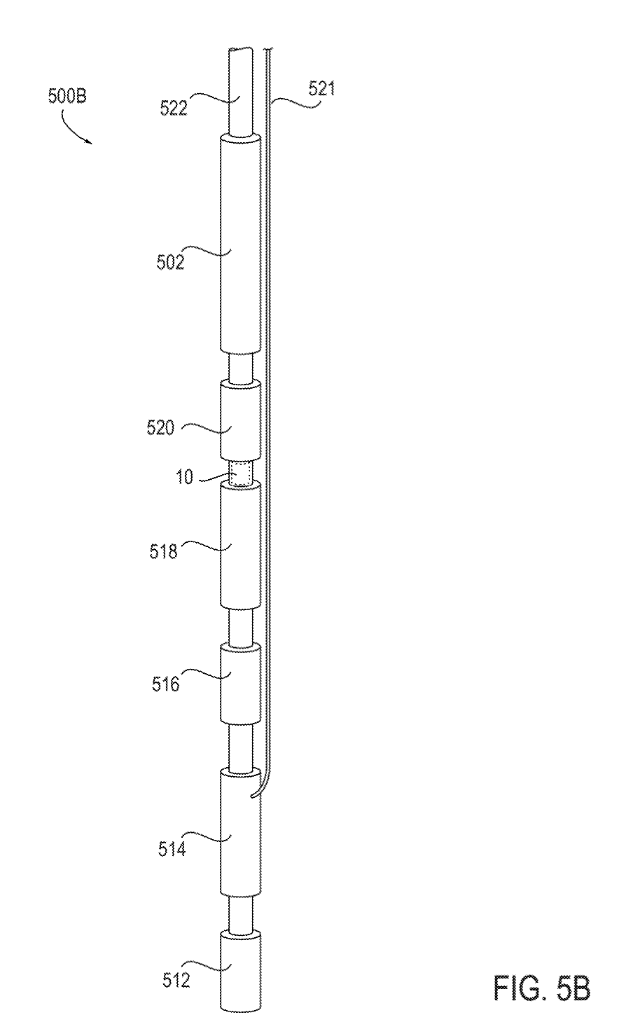

As shown in FIG. 5A, in another embodiment, the fluid handling system can be a system 500A including a separator 512 for separating liquid and gas. The separator 512 has an inlet pipe 514 leading to the separator 512, a liquid outlet 502 and a gas outlet 504. The device 10 can be located in the inlet pipe 514. Gas is received by the first capillary end 6A and expelled from the second capillary end 6B, thereby facilitating separation of the liquid and the gas. Gas 12G in the multiphase fluid 12 exists either as bulk phase or is within the bulk liquid phase 12L as entrained bubbles and dissolved gas. Typically, a pressure drop (e.g., at a valve 516) is taken upstream of the separator 512. In theory, this should disengage some of the dissolved gas. Most design tools incorrectly assume that this disengagement is instantaneous. The disengagement is controlled by gas evolution rates and in instances where gas does not fully disengage, separator performance is hampered. Such degradation of separator performance has grave consequences ranging from downstream equipment damage to impact on production rates because of increased backpressure. Introduction of the capillary 6 of the device 10 downstream of the valve 516 will aid the disengagement of the dissolved gas 12G. The capillary 6 can be designed such that the bubbles 16 created are easily separable by the separator 512.

For illustrative purposes, consider a multiphase (e.g., oil, gas, and water) stream 12 reaching a production choke (a type of valve) 516 upstream of a compact subsea separator 512. After taking a substantial pressure drop at the choke 516, the solution gas 12G must disengage from the liquid 12L to reach the new thermodynamic equilibrium. This can include the time for solution gas to form bubbles, grow, rise and reach the bulk gas-liquid interface 13. This process must conclude within the liquid residence time (which for compact systems can be as low as 30 seconds) in the inlet piping 514 and the vessel 512.

While the time to approach equilibrium after a pressure drop is quick, it is not instantaneous. Quantifying the amount of time required for gas evolution is difficult at best, given the lack of comprehensive predictive models. With short residence times, the margin for error in estimating the extent of gas-liquid separation in the separator 512 is small, but the cost of miscalculations is high. Example embodiments can alter the rate of gas evolution and/or dissolution, greatly reducing this risk and associated cost.

The transience of gas evolving out of solution (e.g., liquid) can be a concern for heavy oil production. Heavy oil is notorious for having processing challenges related to gas-liquid separation with heavy oil emulsions, foams, and gassy crudes, making separation difficult. Typical methods for gas-liquid separation of heavy crude oils involve a combination of gravity separation for long periods of time, chemicals, and heat. Example embodiments can be used to improve gas-liquid separations of these mixtures.

As shown in FIG. 5B, in another embodiment, the fluid handling system is an ESP system 500B including an ESP 502 downstream of a downhole separator 520 for separating liquid and gas. Also present in the ESP system 500 is a protector 518, a seal 516, a motor 514, a sensor 512, production tubing 522 and a power cable 521. The device 10 can be located in an inlet to the separator 520.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

In the foregoing figures showing example embodiments of affecting rates for gas evolution and dissolution, one or more of the components shown may be omitted, repeated, and/or substituted. Accordingly, example embodiments of affecting rates for gas evolution and dissolution should not be considered limited to the specific arrangements of components shown in any of the figures. For example, features shown in one or more figures or described with respect to one embodiment can be applied to another embodiment associated with a different figure or description.

As explained above, gas evolution is the process by which one or more gases 12G that are dissolved in one or more liquids 12L disengages from the liquid(s) due to pressure drop. Gas evolution is a composite of one or more of a number of processes, including but not limited to bubble nucleation, growth, rise, and coalescence. Both dissolution and evolution processes are critical to several oil and gas industry applications, including but not limited to liquid sulphur degassing, artificial lift using gas, boosting/pumping, and separations. There is very limited data available on controlling the rates of gas evolution and dissolution, and the resulting effects of controlling these rates.

Example embodiments of affecting rates for gas evolution and dissolution are described herein with reference to the accompanying drawings, in which example embodiments of affecting rates for gas evolution and dissolution are shown. Affecting rates for gas evolution and dissolution may, however, be embodied in many different forms and should not be construed as limited to the example embodiments set forth herein. Rather, these example embodiments are provided so that this disclosure will be thorough and complete, and will fully convey the scope of affecting rates for gas evolution and dissolution to those of ordinary skill in the art. Like, but not necessarily the same, elements (also sometimes called components) in the various figures are denoted by like reference numerals for consistency.

Terms such as “first,” “second,” “top,” “bottom,” “proximal”, “distal”, “inner,” “outer,” “within,” “front,” “rear,” and “side” are used merely to distinguish one component (or part of a component or state of a component) from another. Such terms are not meant to denote a preference or a particular orientation, and are not meant to limit embodiments of systems for gas evolution and dissolution. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A device for changing a state of a gas relative to a liquid, the device comprising:
a section of conduit comprising at least one inner wall forming a cavity for containing a multiphase fluid flowing therethrough wherein the multiphase fluid comprises a liquid and a gas; and
at least one capillary within the cavity having a first capillary end open to the flowing gas for receiving gas and a second capillary end open to a flowing liquid for expelling gas into the flowing liquid;
wherein gas is passively transferred from the flowing gas to the flowing liquid and the transferred gas forms bubbles in the flowing liquid.

2. The device of claim 1 wherein the capillary is supported by the at least one inner wall.

3. The device of claim 1 wherein the capillary has an inner surface comprising a hydrophobic coating or an oleophobic coating.

4. The device of claim 1 wherein the section of conduit has an inner diameter from 0.6 cm to 152 cm.

5. A fluid handling system comprising:
at least one section of conduit for flowing a multiphase fluid comprising a liquid and a gas therethrough;
at least one system component in fluid communication with the at least one section of conduit; wherein, in the fluid handling system, the multiphase fluid is subjected to at least one substantial change in pressure; and
the device of claim 1 located in the fluid handling system downstream of the substantial change in pressure.

6. The system of claim 5 wherein the at least one substantial change in pressure coincides with the at least one system component and the at least one system component is selected from the group consisting of pipes, pipe fittings, pipe bends, valves, pumps, venturis, reducers and combinations thereof.

7. The system of claim 5 wherein the fluid handling system is a sulfur degassing unit and the at least one system component comprises a degassing vessel for removing hydrogen sulfide and/or hydrogen polysulfide gas from liquid sulfur; and wherein the device of claim 1 is located downstream of a valve on an inlet line feeding liquid sulphur to the degassing vessel.

8. The system of claim 5 wherein the fluid handling system is a gas lift well for supplementing formation gas to lift production fluids from a subterranean reservoir the gas lift well having an unloading valve for injecting gas into the a production tubular for conveying production fluids from the subterranean reservoir; and the at least one system component comprises an injection gas inlet in communication with the unloading valve; wherein the first capillary end is located within the unloading valve and the second capillary end is located at or near an opening of the unloading valve to the production tubular; such that gas can be received by the first capillary end and expelled from the second capillary end thereby facilitating gas lift.

9. The system of claim 5 wherein the at least one system component comprises a pump having a pump inlet and the device of claim 1 is located in the pump inlet.

10. The system of claim 5 wherein the at least one system component comprises a multistage pump having separate pump stages and the device of claim 1 is located in a connector between the separate pump stages.

11. The system of claim 5 wherein the fluid handling system comprises a separator and the device of claim 1 is located in an inlet pipe to the separator.

12. A method for changing a state of a gas relative to a liquid, comprising:
flowing a multiphase fluid comprising a liquid and a gas through a section of conduit comprising at least one inner wall forming a cavity such that a gas-liquid interface is present in the cavity; wherein a capillary is located within the cavity having a first capillary end open to the flowing gas for receiving gas and a second capillary end open to the flowing liquid for expelling gas into the flowing liquid;
such that a stream of the gas is passively received into the first capillary end open to the flowing gas and the stream of the gas is expelled from the second capillary end into the flowing liquid thereby forming bubbles of the gas in the flowing liquid.

13. The method of claim 12 wherein the capillary is supported by the at least one inner wall.

14. The method of claim 12 wherein the capillary has an inner capillary surface and the inner capillary surface is oleophobic.

15. The method of claim 12 wherein the capillary has an inner capillary surface and the inner capillary surface is hydrophobic.

16. The method of claim 12 wherein the section of conduit is positioned downstream of a valve in an inlet to a degassing vessel for removing hydrogen sulfide and/or hydrogen polysulfide gas from liquid sulfur; and wherein the first capillary end is located within the inlet and the second capillary end is located within a liquid sulfur phase in the degassing vessel; such that hydrogen sulfide and/or hydrogen polysulfide gas is received by the first capillary end and expelled from the second capillary end thereby facilitating removal of the hydrogen sulfide and/or hydrogen polysulfide gas from the liquid sulfur.

17. The method of claim 12 wherein the section of conduit is located in a gas lift well for supplementing formation gas to lift production fluids from a subterranean reservoir and positioned such that the first capillary end is located within an unloading valve for injecting gas into the gas lift well and the second capillary end is located at or near an opening of the unloading valve to a production tubular for conveying production fluids; such that gas is received by the first capillary end and expelled from the second capillary end thereby facilitating gas lift.

18. The method of claim 12 wherein the section of conduit is located in a pump inlet and/or in a connector between pump stages in a pump.

19. The method of claim 12 wherein the section of conduit is located in an inlet pipe to a separator for separating the liquid and the gas; such that the gas is received by the first capillary end and expelled from the second capillary end thereby facilitating separation of the liquid and the gas.

20. The method of claim 12 wherein the second capillary end is located within a bottom half of the flowing liquid in the cavity.

21. The method of claim 12 wherein the second capillary end is located within a top quarter of the flowing liquid in the cavity.
